(19) United States
(12) Patent Application Publication
(10) Pub. No.: US 2025/0280448 A1
(43) Pub. Date: Sep. 4, 2025

(54) RANDOM ACCESS CHANNEL (RACH) CONFIGURATIONSIN ASYMMETRIC TRANSMISSION AND RECEPTION POINT (TRP) DEPLOYMENTS

(71) Applicant: Lenovo (United States) Inc., Morrisville, NC (US)

(72) Inventor: Khaled Nafez Rauf ARDAH, Ilmenau (DE)

(21) Appl. No.: 19/192,082

(22) Filed: Apr. 28, 2025

(51) Int. Cl. H04W 74/0833; H04L 5/00; H04W 72/23; H04W 72/51

(52) U.S. Cl. CPC H04W 74/0833; H04L 5/0048; H04W 72/23; H04W 72/51

(57) ABSTRACT

Various aspects of the present disclosure relate to random access procedures for asymmetric transmission and reception point (TRP) deployments, such as when a UE is in a radio resource control (RRC)-idle mode of operation. The disclosure provides random access procedures for a UE, where available TRPs have different or asymmetric configurations (e.g., one TRP being applicable for DL and UL and one TRP being applicable for UL-only). For example, a wireless communications system may establish or enhance the mapping of slots between TRP random access channel (RACH) configurations, such as a mapping of synchronization signal blocks (SSBs) to ROs (e.g., an SSB-to-RO mapping rule). In doing so, the network can enable a UE to select and access available TRPs via various valid slots associated with the TRPs.

### TECHNICAL FIELD

The present disclosure relates to wireless communications, and more specifically to performing random access channel (RACH) configurations in asymmetric transmission and reception point (TRP) deployments.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In the wireless communications system, a user communication device and a network communication device may support random access (RA), for example, to establish a connection between the user communication device and the network communication device. In some cases, one or both of the user communication device and the network communication device may support time division duplexing (TDD), in which resources may be split (e.g., allocated, scheduled, divided) between uplink (UL) resources and downlink (DL) resources in a time domain. The user communication device can utilize configured time-frequency resource occasions to transmit a preamble and initiate an RA procedure.

### SUMMARY

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, processors, and systems that enable the performance of random access in asymmetric transmission and reception point (TRP) deployments. The methods, apparatuses, processors, and systems of the present disclosure each have several innovative aspects, no single one of which is solely responsible for the desirable features disclosed herein.

A UE for wireless communication is described. The UE may be configured to, capable of, or operable to perform one or more operations as described herein. For example, the UE may comprise at least one memory and at least one processor coupled with the at least one memory and configured to cause the UE to access at least two random access channel (RACH) configurations, wherein a first RACH configuration is associated with a first TRP and a second RACH configuration is associated with a second TRP, wherein a first mapping between one or more synchronization signal blocks (SSBs) and one or more ROs is applicable for a first valid RO based at least in part on the first RACH configuration, wherein the first valid RO is applicable for wireless communication with the first TRP and the second TRP, and wherein a second mapping between one or more SSBs and one or more ROs is applicable for a second valid RO based at least in part on the second RACH configuration, wherein the second valid RO is applicable for wireless communication with the second TRP, and transmit, based at least in part on the at least two RACH configurations, a random access preamble on a selected RO from the first valid RO and the second valid RO.

A processor for wireless communication is described. The processor may be configured to, capable of, or operable to perform one or more operations as described herein. For example, the processor may comprise at least one memory and at least one controller coupled with the at least one memory and configured to cause the processor to access at least two RACH configurations, wherein a first RACH configuration is associated with a first TRP and a second RACH configuration is associated with a second TRP, wherein a first mapping between one or more SSBs and one or more ROs is applicable for a first valid RO based at least in part on the first RACH configuration, wherein the first valid RO is applicable for wireless communication with the first TRP and the second TRP, and wherein a second mapping between one or more SSBs and one or more ROs is applicable for a second valid RO based at least in part on the second RACH configuration, wherein the second valid RO is applicable for wireless communication with the second TRP, and transmit, based at least in part on the at least two RACH configurations, a random access preamble on a selected RO from the first valid RO and the second valid RO.

A method performed or performable by the UE is described. The method may comprise accessing at least two RACH configurations, wherein a first RACH configuration is associated with a first TRP and a second RACH configuration is associated with a second TRP, wherein a first mapping between one or more SSBs and one or more ROs is applicable for a first valid RO based at least in part on the first RACH configuration, wherein the first valid RO is applicable for wireless communication with the first TRP and the second TRP, and wherein a second mapping between one or more SSBs and one or more ROs is applicable for a second valid RO based at least in part on the second RACH configuration, wherein the second valid RO is applicable for wireless communication with the second TRP, and transmitting, based at least in part on the at least two RACH configurations, a random access preamble on a selected RO from the first valid RO and the second valid RO.

In some implementations of the UE, processor, and method described herein, the first TRP supports DL and UL and the second TRP supports a UL-only capability.

In some implementations of the UE, processor, and method described herein, the UE, processor, and method may further be configured to, capable of, performed, performable, or operable to receive the first RACH configuration and the second RACH configuration via a system information block (SIB) associated with the first TRP during a downlink synchronization procedure.

In some implementations of the UE, processor, and method described herein, the SIB includes a first RACH-ConfigCommon information element (IE) to indicate the first RACH configuration and a second RACH-ConfigCommon IE to indicate the second RACH configuration.

In some implementations of the UE, processor, and method described herein, the SIB includes a shared RACH-ConfigCommon IE to indicate the first RACH configuration and the second RACH configuration and a RACH configuration parameter that offsets second TRP parameters of the second RACH configuration.

In some implementations of the UE, processor, and method described herein, the UE, processor, and method may further be configured to, capable of, performed, performable, or operable to determine one or more valid RO slots for the second TRP based on candidate RO slots indicated by the first RACH configuration.

In some implementations of the UE, processor, and method described herein, the UE, processor, and method may further be configured to, capable of, performed, performable, or operable to determine one or more valid RO slots shared by the first TRP and the second TRP and determine one or more valid slots unique to the first TRP and the second TRP.

In some implementations of the UE, processor, and method described herein, the UE, processor, and method may further be configured to, capable of, performed, performable, or operable to transmit a PRACH preamble on an RO of an RO group selected from: a group of ROs valid for the first TRP and the second TRP, a group of ROs only valid for the first TRP, or a group of ROs only valid for the second TRP.

In some implementations of the UE, processor, and method described herein, the UE, processor, and method may further be configured to, capable of, performed, performable, or operable to transmit a PRACH preamble on an RO of a first available group of ROs.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit a RACH message that contains a first RACH configuration for a first TRP and a second RACH configuration for a second TRP and receive, from a UE, a physical RACH (PRACH) preamble based on the first RACH configuration and the second RACH configuration.

A method performed or performable by the network entity is described. The method may comprise transmitting a RACH message that contains a first RACH configuration for a first TRP and a second RACH configuration for a second TRP and receiving, from a UE, a PRACH preamble based on the first RACH configuration and the second RACH configuration.

In some implementations of the network entity and method described herein, the first RACH configuration and the second RACH configuration are associated with a shared SSB-to-RO mapping between first TRP and the second TRP.

In some implementations of the network entity and method described herein, the first TRP supports DL and UL and the second TRP supports a UL-only capability.

In some implementations of the network entity and method described herein, the network entity and method may further be configured to, capable of, performed, performable, or operable to transmit the first RACH configuration and the second RACH configuration via a SIB.

In some implementations of the network entity and method described herein, the SIB includes a first RACH-ConfigCommon IE to indicate the first RACH configuration and a second RACH-ConfigCommon IE to indicate the second RACH configuration.

In some implementations of the network entity and method described herein, the SIB includes a shared RACH-ConfigCommon IE to indicate the first RACH configuration and the second RACH configuration and a RACH configuration parameter that offsets second TRP parameters of the second RACH configuration.

### BRIEF DESCRIPTION OF THE DRAWINGS

FIG. 1 illustrates an example of a wireless communications system in accordance with aspects of the present disclosure.

FIG. 2 illustrates an example asymmetric TRP deployment in accordance with aspects of the present disclosure.

FIG. 3 illustrates an example random access procedure in an asymmetric TRP deployment in accordance with aspects of the present disclosure.

FIG. 4 illustrates an example SSB-to-ROs mapping in an asymmetric TRP deployment in accordance with aspects of the present disclosure.

FIGS. 5A-5B illustrate example valid RO slots at multiple TRPs in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

An asymmetric TRP deployment may involve multiple TRPs, such that one TRP supports both downlink (DL) and uplink (UL) transmissions with a UE (or UEs), while two or more additional TRPs support only uplink (UL) transmissions. For example, in an asymmetric TRP deployment with a single DL TRP (sTRP) and multiple UL TRP (mTRP), a UE may receive DL transmissions from a first network node (e.g., a TRP A) and transmit UL transmissions to multiple network nodes, such as the TRP A and a different, non-col-located network node (e.g., a TRP B). Such an asymmetric TRP deployment may provide various benefits, including enhanced UL throughput, reduced energy consumption (due to fewer DL transmissions), among other benefits.

Various aspects of the present disclosure relate to a random access procedure for asymmetric TRP deployments, such as when a UE is in a radio resource control (RRC) idle mode. For example, a UE may support a random access procedure in cases where available TRPs have different or asymmetric configurations (e.g., one TRP supporting both DL and UL communications, and another TRP supporting only UL communications). In RRC idle mode, the UE may perform a random access procedure to establish or re-establish a connection with a network, such as via a TRP (e.g., a base station) within an asymmetric TRP deployment. The UE may transmit a random access preamble and receive a random access response message that indicates the configurations of the available TRPs. Based on the identified configurations, the UE may select one of the available TRPs and transmit a PUSCH transmission to the selected TRP.

In some cases, the different TRPs may have different TDD patterns, where valid RO slots are different between TRPs (e.g., between a UL/DL TRP and a UL-only TRP). The wireless communications system, therefore, may establish or enhance the mapping of slots between TRP RACH configurations, such as a mapping of synchronization signal blocks (SSBs) to ROs (e.g., an SSB-to-RO mapping rule). In doing so, the network can enable a UE to select and access available TRPs via various valid slots associated with the TRPs.

Thus, the UE may experience improvements in connecting to the network through an asymmetric TRP deployment, thereby providing the benefits, such as improved throughput and power saving, during random access procedures and in other scenarios where the UE is in an RRC idle or RRC inactive mode, among other benefits.

Aspects of the present disclosure are described in the context of a wireless communications system.

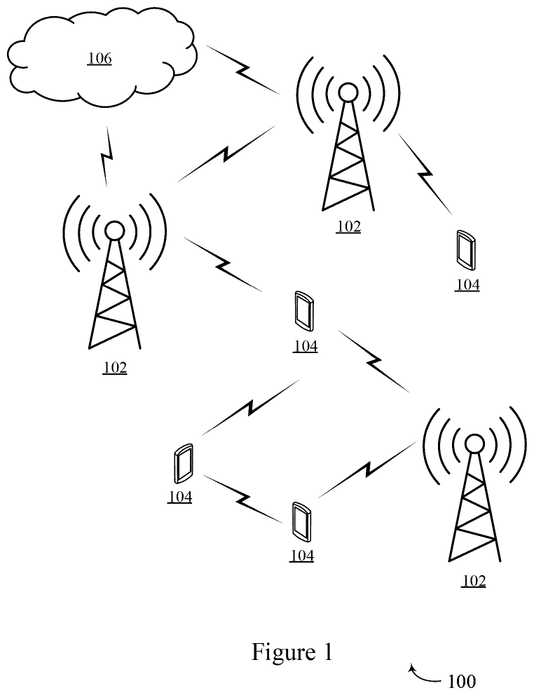

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, the wireless communications system 100 enables random access procedures for the UE 104 with respect to asymmetric TRP deployments. There are two types of random access procedures, Type 1 (e.g., 4-step random access) and Type 2 (e.g., 2-step random access), where Type 2 may reduce latency during random access by controlling signaling used during the procedure.

For example, in an unpaired spectrum operation (e.g., a time-division duplex (TDD) mode), the random access latency may be bounded or limited by a configured slot pattern (via the tdd-UL-DL-ConfigurationCommon), where a DL/UL heavy slot pattern provides less time resource opportunities for the UE 104 to transmit and/or receive random access messages.

A subband full-duplex (SBFD) framework enables frequency domain resources where DL or flexible slots may be subdivided into multiple DL-UL non-overlapping subbands, increasing the time resource opportunities for the UE 104 to transmit and receive random access messages. However, enabling random access in an asymmetric TRP deployment (e.g., DL sTRP UL mTRP) may further reduce random access latency, since deployed UL-only TRPs do not suffer from self-interference (e.g., with respect to SBFD) case and may have more UL time-frequency resources, reducing the random access latency and UL transmit power.

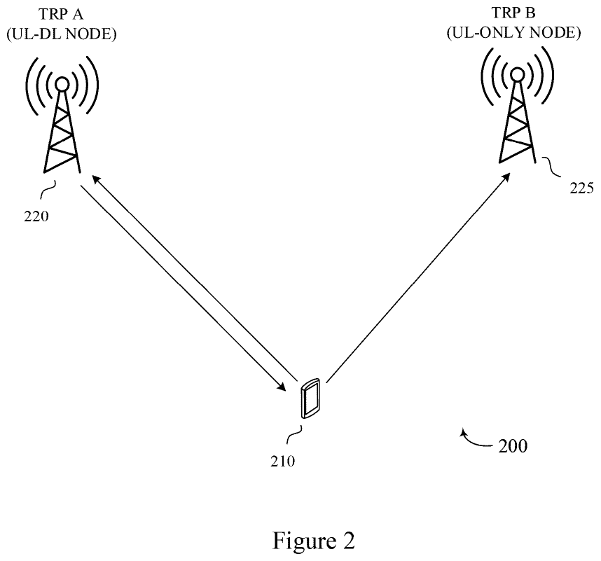

FIG. 2 illustrates an example asymmetric TRP deployment 200 in accordance with aspects of the present disclosure. A UE 210 may perform communication (e.g., transmit wireless communication and/or receive wireless communication) with multiple TRPs, including a first TRP 220 (e.g., a TRP A), which support (e.g., configured for or applicable for) both UL and DL communications, and a second TRP 225 (e.g., a TRP B), which only supports (e.g., only configured for or only applicable for) UL communications).

The UE 210 may perform random access by initiating a connection with a single network node (e.g., the TRP 220), which transmits reference signals (RSs), such as synchronization signal blocks (SSBs), a channel state information RS (CSI-RS), etc. The UE 210 transmits one or more random access messages (e.g., a Msg. 1) using one or more transmit (Tx) beams corresponding to a selected SSB and/or the CSI-RS and receives one or more random access messages (e.g., a Msg.2) using one or more receive (Rx) beams that is determined/selected during a downlink synchronization phase (e.g., listening for and measuring the SSBs/CSI-RS). Thus, the UE 210 utilizes a same spatial-domain transmission filter as used to receive the SSBs/CSI-RS.

The UE 210 may determine slot configurations using a provided tdd-UL-DL-ConfigurationCommon in a system information block one (e.g., SIB1). However, within the asymmetric TRP deployment 200, the slot patterns of associated or TRPs (e.g., TRP A and TRP B) may be different, and thus, there are different valid UL slots for the UE 210 during random access procedures. In other words, the TRP 220 and the TRP 225 may provide different valid slots for use by the UE 210 during Msg1/Msg3/MsgA transmissions.

In some embodiments, the UE 210 may trigger a random access procedure in response to a triggering event (e.g., initial access, handover, beam failure, and so on) or in response to receiving an indication from a network node (e.g., via a physical downlink control channel (PDCCH) order message). Initially, the UE 210 receives and measures the reference signal resource power (RSRP) of the SSBs/CSI-RS transmitted (periodically) from the TRPs 220, 225. In some cases, the UE 210 may receive an indication of the SSB/preamble/RACH occasion (RO) from an TRP via dedicated RRC signaling, dedicated medium access control element (MAC-CE) signaling, dedicated downlink control information (DCI) signaling, and so on.

The UE 210 selects an SSB/CSI-RS index (e.g., a beam index) with a highest power. The UE 210 may decode system information (e.g., SIB1) contents, including a RACH configuration. For example, the system information may include an indication from the TRP 220 that the TRP 220 is associated with other TRPs (e.g., the TRP 225) that have a UL-only configuration. For example, the system information may include a 1-bit indication, where “0” indicates that the TRP 220 is not associated with other UL-only TRPs and “1” indicates that the TRP 220 is associated with other UL-only TRPs (e.g., the TRP 225) having UL-only TDD patterns. As another example, the SIB1 may indicate the tdd-UL-DL-ConfigurationCommon (e.g., a slot DL-UL pattern) of associated UL-only TRPs.

In some embodiments, when the TRP 220 is associated with one or more UL-only TRPs, the SIB1 may indicate a valid RO indicator and/or a valid PUSCH occasion (PO) indicator. For example, the SIB1 may include a bitmap or bitmaps that indicate the valid ROs and/or the valid POs associated with the UL-only TRPs.

The UE 210 transmits one or more random access preambles (e.g., PRACH preambles), via Msg1 during a Type 1 random access procedure or MsgA during a Type 2 random access procedure. The UE 210 may transmit the random access procedure via valid ROs associated with selected/indicated SSBs of the TRP 220. The UE 210 may transmit a Msg1 using a Tx beam corresponding to a Rx beam of a selected or indicated SSB/CSI-RS, where the UE 210 uses a same spatial-domain transmission filter as the filter used to receive a selected or indicated SSB/CSI-RS.

In some cases, the UE 210 repeats the Msg1 transmission for a number of times (e.g., N_{preamble}^{rep}) where the number of times is indicated to the UE 210 via the SIB1, the PDCCH order message, and/or determined by the UE 210 based on an SSB RSRP measurement (e.g., where the N_{preamble}^{rep} increases with a decreasing SSB RSRP). The UE 210 may transmit one or more preambles (e.g., Msg1) using different Tx beams, such as when the SIB1 indicates that the TRP 220 is associated with UL-only TRPs (e.g., the TRP 225) In some cases, the UE 210 may receive an indication of a beam-pattern transmission.

A network node may receive the Msg1 via the TRPs (e.g., via the TRP 220 and/or the TRP 225). Based on the network architecture, the network node may be a centralized processing unit (CPU) that receives measurements from TRPs and/or network information (e.g., load information) and determines or selects TRPs based on the measurements/information. In some cases, the network node may be or include a scheduler entity of a TRP (e.g., the TRP 220). For example, the TRPs may send/share/transmit measurements to the TRP 220 (e.g., via an over-the-air (OTA) interface, an Xn interface, and so on), such as when the measurements are above a certain threshold.

The network node may determine (e.g., based on Msg1 received power measurements at each TRP) the TRP to use for receiving future UL messages (e.g., Msg3) from the UE 210. For example, network node may coordinate with and/or synchronize the associated TRPs, such as facilitate information exchanges (e.g., SSB configurations, RACH configurations) for the TRPs.

For example, when a certain TRP (e.g., TRP 220) has a better or higher Msg1 received power measurement, the network node may determine to direct the UE 210 to transmit its UL communications/Msg3 towards the certain TRP. Thus, even when the UE 210 transmits the random access preamble (e.g., Msg1) on an RO associated with a selected SSB of the TRP 220 using a Tx beam corresponding to an Rx beam of the selected SSB, the TRP 225 may receive the Msg1 with a higher power (with respect to the power of the TRP 220) due to a better channel quality with the UE 210.

The network mode may generate and transmit a random access response (RAR) message (e.g., Msg2) in response to receiving the Msg1 from the UE 210. For example, the network node may transmit the RAR message via the TRP 220 using the same SSB beams used for receiving the Msg1 from the UE 210, while the Msg2 is received by the UE 210 during a time-window using the same spatial-domain filters used to transmit the Msg1.

In some cases, the Msg2 may indicate one or more configuration sets (or identifiers or sets of configurations), where each configuration set contains a time-advance (TA) command, a UL Grant, a UL Tx beam index (in case UE transmits preamble using two or more UL Tx beams), and/or a pathloss offset. Each configuration set may be associated with a TRP index, TRP identifier, or a tdd-UL-DL-ConfigurationCommon configuration index.

For example, when the network node determines to direct the UE 210 to transmit the Msg3 towards a certain TRP (e.g., the TRP 220), network node may indicate, in the Msg2, a set of configurations or identifiers that include a TA command, a UL Tx beam index, and a UL Grant all associated with the TRP index/ID or TRP tdd-UL-DL-ConfigurationCommon configuration index of the certain TRP. In some cases, such as when the certain TRP is a UL-only TRP, the Msg2 may include a pathloss offset that is determined by comparing pathloss values of the associated TRPs (e.g., a difference between pathloss values of the TRP 220 and the TRP 225). The UE 210 may utilize the pathloss offset to determine the UL transmit power of the Msg3. In some cases, the pathloss offset and/or the TA command may be indicated by an index value pointing to a predefined value.

In some embodiments, the network node may determine to direct the UE 210 to transmit the Msg3 to both TRPs 220, 225. Based on the determination, the network node may indicate, in the Msg2, two sets of configurations (e.g., a set of configurations X and a set of configurations Y), where each set of configurations includes a TA command, a pathloss offset, a UL Tx beam index, and a UL Grant associated with the TRP indexes/IDs or TRP tdd-UL-DL-ConfigurationCommon configuration indexes.

In some embodiments, the network node may indicate one set of configurations (via Msg2) as a fallback configuration, where another set of configurations is indicated as a primary set of configurations). The UE 210 may use the fallback configuration when, for example, there is no receipt of a subsequent Msg4 within a predefined time window. In some cases, the network node may indicate to the UE 210 (e.g., in Msg4) to use the fallback configuration.

As described herein, in some embodiments, an asymmetric TRP deployment may include TRPs having different TDD slot patterns.

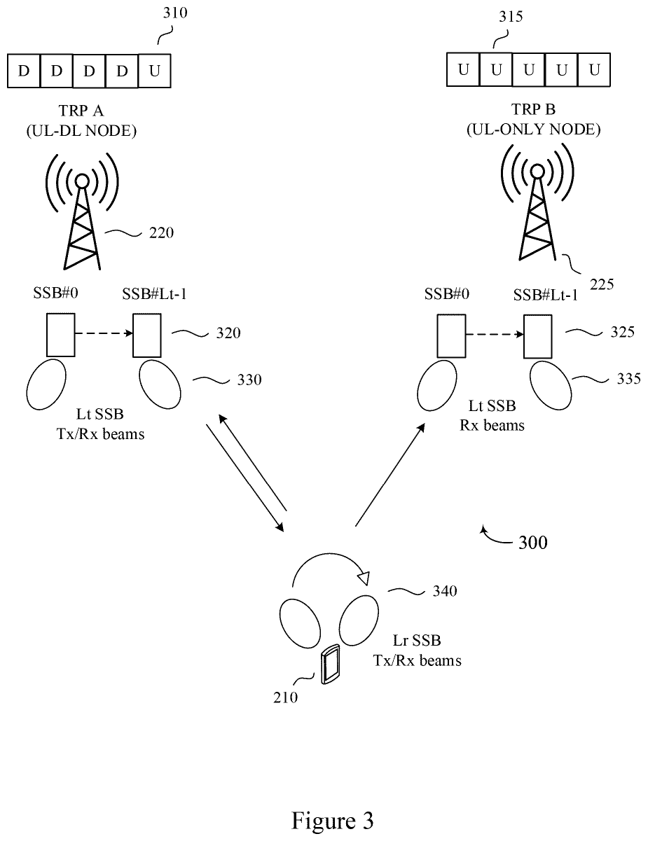

FIG. 3 illustrates an example random access procedure in an asymmetric TRP deployment 300 in accordance with aspects of the present disclosure. The asymmetric TRP deployment 300 may include a TRP 220 associated with a first TDD slot pattern 310, which includes both DL and UL slots, and a TRP 225 associated with a second TDD slot pattern 315, which only includes UL slots. A UE 210 may measure (via one or more (e.g., Lᵣ) SSB Rx beams 340) a receive power of SSBs 320 of the TRP 220 and/or a receive power of SSBs 325 of the TRP 225, and transmit a preamble, via one or more transmit beams 340, to the TRP 220 and the TRP 225, which is received via one or more SSB Rx beams (e.g., Lₜ) 330, 335 at the TRP 220 and the TRP 225.

In some embodiments, such as when the TDD slot patterns 310, 315 are different and the UE 210 is directed to transmit a Msg3 towards the TRP 225 (where the TRP 220 is associated with the selected/indicated SSB 330), the Msg2 may indicate the tdd-UL-DL-ConfigurationCommon of the TRP 225. In some cases, the Msg2 may indicate that the Msg2 configuration set is associated with a TRP (e.g., the TRP 225) with a UL-only TDD pattern (e.g., the TTD patterns 315) using a 1 bit indication (e.g., “0” indicates that a TRP has a same tdd-UL-DL-ConfigurationCommon as the TRP 220 and “1” indicates that the TRP has a UL-only TDD pattern). In some cases, such as when the TRP type indication (e.g., a TRP-type) is not included in the Msg2, the UE 210 may assume that the TRP is configured for UL and DL.

In some cases, the UE 210 may transmit the Msg3 (e.g., a scheduled PUSCH) using one or more sets of configurations (e.g., indicated by Msg2) and may receive the Msg4 using the same spatial-domain filters as used to transmit the Msg1. The UE 210, therefore, may transmit the Msg3 towards the TRP 225 (e.g., via the one or more SSB Rx beams 335) on a slot n, even when the slot n is indicated as DL for the TRP 220, as the slot is indicated as UL for the TRP 225 (e.g., within the TDD pattern 315).

As described herein, in some embodiments, the TRPs may be associated with different TDD patterns, such as where valid RO slots are different between the TRP 220 (e.g., a UL/DL TRP) and the TRP 225 (e.g., a UL-only TRP). For example, the TRP 220 may be associated with or assisted by the TRP 225, which has a different slot pattern (e.g., tdd-UL-DL-ConfigurationCommon). Thus, the system information (e.g., the SIB1) may indicate a separate RACH configuration for each TRP (e.g., via a separate RACH-ConfigCommon IE), such as a first RACH Configuration for the TRP 220 and a second RACH Configuration for the TRP 225.

In some cases, the SIB1 indicate a same RACH configuration for all TRPs (e.g., via a same RACH-ConfigCommon IE, which indicates a number of SSBs per RACH occasion), along with an indication of a separate RACH configuration parameter/offset (e.g., a msg1-FrequencyStart, a msg1-FDM, and so on), that overrides or offsets, for the TRP 225, the parameters within the shared RACH configuration.

Thus, the override or offset information/indication may indicate a number of PRACH ROs that have been FDMed in one time instance (via the msg1-FDM), an offset of/to a lowest PRACH transmission occasion in a frequency domain with respect to a physical resource block 0 (via the msg1-FrequencyStart), and so on. For example, the UE 210 may determine or derive a separate RACH configuration for the TRP 225 by modifying or updating the first RACH configuration (e.g., for the TRP 220), such as by replacing the msg1-Frequency Start or msg1-FDM.

In some embodiments, the SSB-to-RO mapping rule may be enhanced for an asymmetric TRP deployment. Currently, the UE 210 may map provided N_{TX}^{SSB} SSBs to valid ROs according to a radio resource control (RRC) parameter ssb-perRACH-OccasionAndCB-PreamblesPerSSB. The RRC parameter may indicate information about the number of SSBs per RACH occasion (e.g., a value of oneEighth corresponds to one SSB associated with 8 RACH occasions, a value of oneFourth corresponds to one SSB associated with 4 RACH occasions, and so on), and/or indicate a number of Contention Based preambles per SSB (e.g., a value n4 corresponds to 4 Contention Based preambles per SSB, a value n8 corresponds to 8 Contention Based preambles per SSB, and so on).

Also, an SSB block index within the SIB1 (e.g., ssb-PositionsInBurst or in the ServingCellConfigCommon may be mapped to valid PRACH occasions, in the following order. First, in an increasing order of preamble indexes within a single PRACH occasion, next, in an increasing order of frequency resource indexes for frequency multiplexed PRACH occasions, next, in increasing order of time resource indexes for time multiplexed PRACH occasions within a PRACH slot, and last, in increasing order of indexes for PRACH slots.

The UE 210, as described herein, may receive, a single or one RACH configuration and assume that valid RO slots (or valid ROs) at the TRP 220 are also valid RO slots (or valid ROs) at TRP 225, The UE 210, therefore, may assumes that (or apply) the same RACH Configuration and the same SSB-to-RO mapping are applicable and/or configured at both TRPs 220, 225 (e.g., for both TRP types). The UE 210 may assume the RO slots are valid for both TRPs when the UL-DL pattern of the TRPs is the same, when one TRP (e.g., the TRP 225) has a UL-only TDD pattern, and/or when the UE 210 is unaware of the asymmetric TRP deployment (e.g., the UE 210 does not have knowledge of the association between the TRPs).

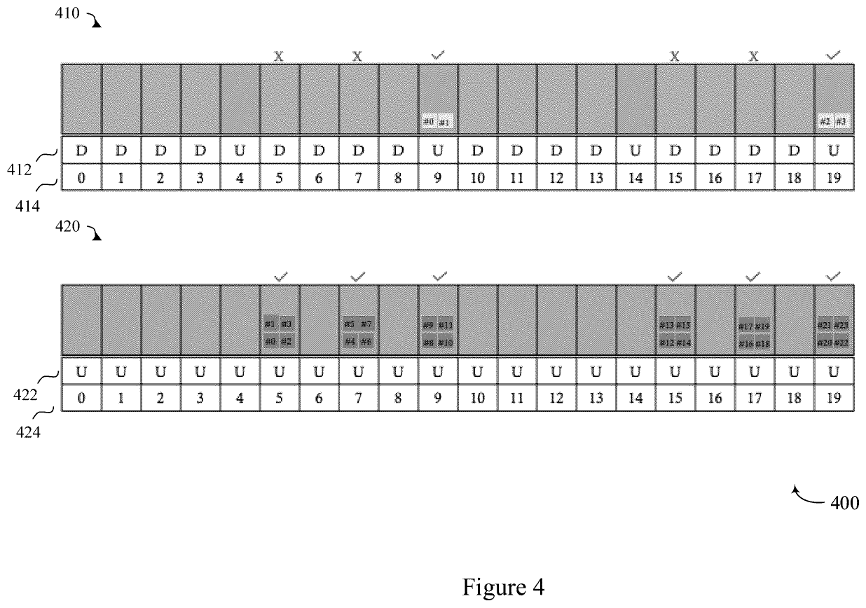

In some embodiments, the UE 210 may assume a separate RACH configuration and SSB-to-RO mapping is applied to valid ROs at each of the TRPs 220, 225. FIG. 4 illustrates an example SSB-to-ROs mapping 400 in an asymmetric TRP deployment in accordance with aspects of the present disclosure. The TRP 220 is associated with a RACH configuration 410 (e.g., a RACH configuration having a PRACH configuration index X, a msg1-FDM=1, and so on), which has a TDD pattern 412 and related slot numbers 414. The TRP 225 is associated with a RACH configuration 420 (e.g., a RACH configuration having a PRACH configuration index Y, a msg1-FDM=2, and so on), which has a TTD pattern 422 and related slot numbers 424.

Each RACH configuration includes valid ROs (e.g., indicated by checkmarks) and invalid ROs (indicated by an X). For example, slots 5, 7, 9, 15, 17, and 19 are indicated/determined as RO slots by an indicated PRACH configuration index for the TRP 220, where slots 9 and 19 are considered valid ROs because they fall within an UL slot (as indicated by the TDD pattern 412). Similarly, slots 5, 7, 15, and 17 are invalidated as they fall within a DL slot. However, for TRP 225, the slots 5, 7, 9, 15, 17, and 19 are valid ROs slots, because the TDD pattern 422 at the TRP 225 includes all UP slots.

In some embodiments, the UE 210 may assume that indicated candidate RO slots or subframes at the TRP 220 (e.g., indicated by its associated/corresponding RACH configuration index) may also be indicated candidate RO slots/subframes at the TRP 225, even when an indicated RACH configuration index for the TRP 225 does not indicate the same RO slots/subframes as candidate RO slots/subframes. Thus, when separate RACH configurations are provided for each TRP, the UE 210 may modify the RACH configuration for the TRP 225 to include additional candidate or valid RACH slots/ROs.

In some cases, the TRP 220 may be associated with a RACH configuration index X, which indicates that slot #n is a candidate RO slot, while TRP 225 may be associated with a RACH configuration index Y, which does not indicate slot #n as a candidate RO slot. The UE 210 may then assume that slot #n is also a candidate RO slot, in addition to other candidate RO slots identified by the RACH configuration index Y. For example, if the RACH configuration index X indicates that candidate RO slots at the TRP 220 are slots {3, 4, 5}, and the RACH Configuration index Y indicates that candidate ROs slots at the TRP 225 are slots {4, 6, 8}, the UE 210 may assume that the candidate RO slots at the TRP 225 are the slots {3, 4, 5, 6, 8}.

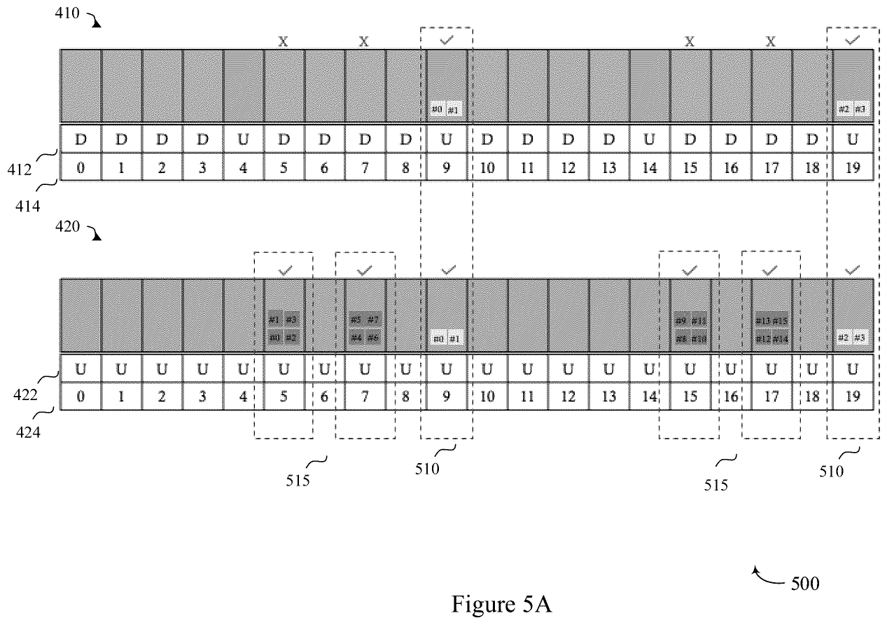

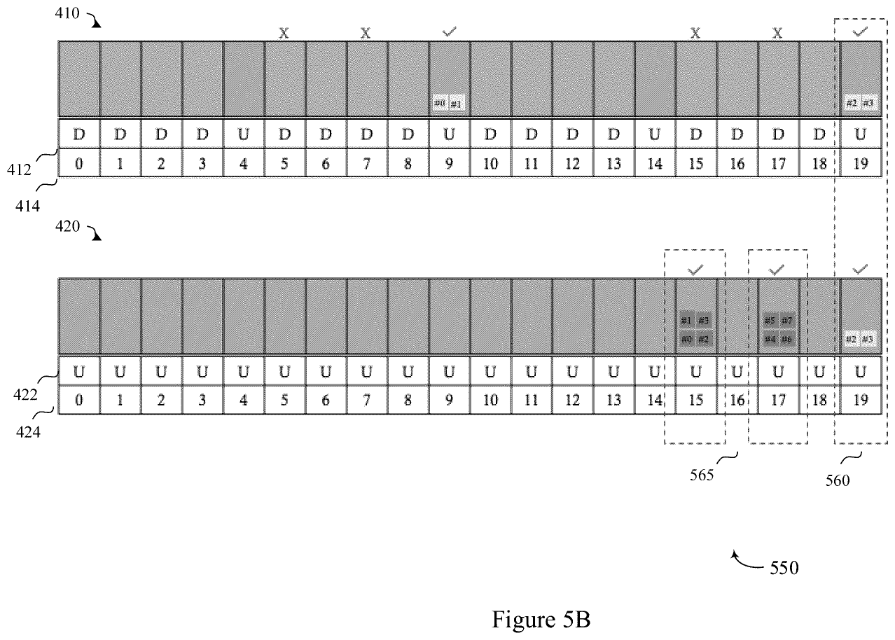

In some embodiments, the UE 210 may first determine jointly valid RO slots between associated TRPs (e.g., the TRP 220 and the TRP 225) and any uniquely valid RO slots at the associated TRPs. FIGS. 5A-5B illustrate example valid RO slots at multiple TRPs in accordance with aspects of the present disclosure.

For example, FIG. 5A depicts RACH configurations 500 for the TRPs 220, 225, where jointly valid RO slots 510 between the TRP 220 and the TRP 225 are slots {9, 19} and uniquely valid RO slots 515 at the TRP 225 are slots {5, 7, 15, 17}. As another example, FIG. 5B depicts RACH configurations 550 for the TRPs 220, 225, where one jointly valid RO slot 560 between the TRP 220 and the TRP 225 is slot {19} and uniquely valid RO slots 565 at the TRP 225 are slots {15, 17}.

Based on the RACH configurations, the UE 510, in some cases, may assume that a same RACH configuration and SSB-to-ROs mapping corresponding to the TRP 220 is used/applied on jointly valid RO slots at the TRP 220 and TRP B 225 (e.g., Slot #9 and Slot #19 in FIG. 5A, or Slot #19 in FIG. 5B) and may assume that a different RACH configuration and SSB-to-ROs mapping corresponding to the TRP 225 is used/applied on uniquely/additional valid RO slots at the TRP 225 (e.g., Slot #5, Slot #7, Slot #15, and Slot #17 in FIG. 5A).

In some embodiments, the UE 210, during a random access procedure, may repeat a Msg1 transmission using an initially selected spatial domain transmission filter on a selected ROs group or set. For example, the UE 210 may be configured and/or receive an indication to select a group of ROs from an indication of an RO type, such as a type associated with only jointly valid RO slots, a type associated with uniquely valid RO slots for the TRP 220 and uniquely valid RO slots for the TRP 225. As another example, the UE 210 may select a set or group of ROs based on an initially available RO group type (e.g., when a first available RO is from a group of jointly valid RO slots, the UE 210 selects a group or set of ROs for a spatial domain transmission filter from valid ROs the of jointly valid RO slots). In some cases, the network node may transmit an index corresponding to predetermined/defined rules to indicate the RO group type indication to the UE 210.

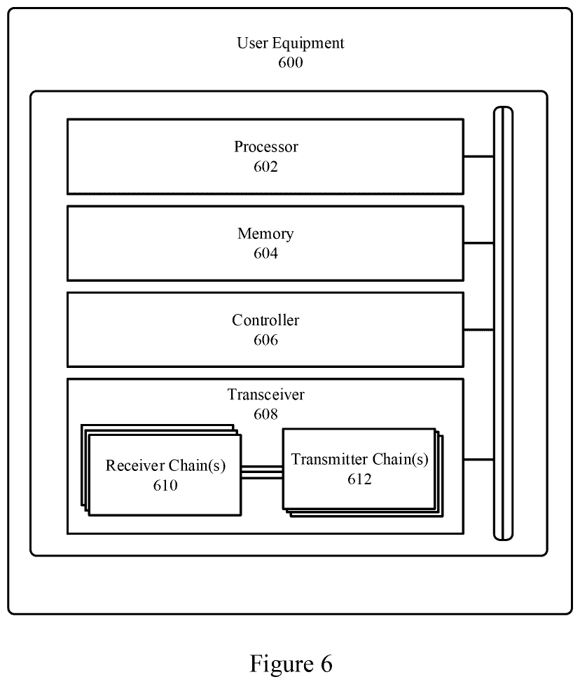

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein.

For example, the processor 602 may support wireless communication at the UE 600 in accordance with examples as disclosed herein. The UE 600 may be configured to support a means for accessing at least two RACH configurations, wherein a first RACH configuration is associated with a first TRP and a second RACH configuration is associated with a second TRP, wherein a first mapping between one or more SSBs and one or more ROs is applicable for a first valid RO based at least in part on the first RACH configuration, wherein the first valid RO is applicable for wireless communication with the first TRP and the second TRP, and wherein a second mapping between one or more SSBs and one or more ROs is applicable for a second valid RO based at least in part on the second RACH configuration, wherein the second valid RO is applicable for wireless communication with the second TRP, and transmitting, based at least in part on the at least two RACH configurations, a random access preamble on a selected RO from the first valid RO and the second valid RO.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 510, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

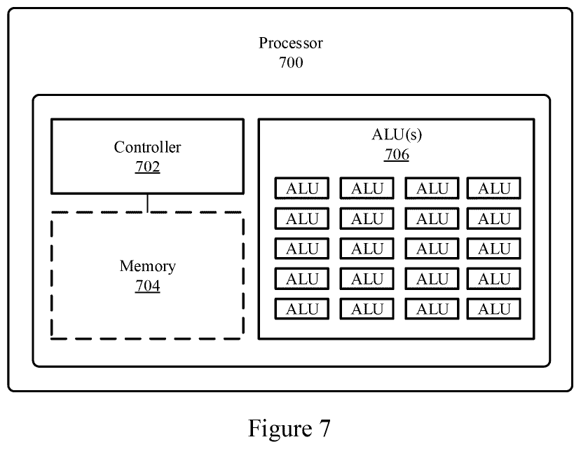

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. For example, the processor 700 may be configured to support a means for accessing at least two RACH configurations, wherein a first RACH configuration is associated with a first TRP and a second RACH configuration is associated with a second TRP, wherein a first mapping between one or more SSBs and one or more ROs is applicable for a first valid RO based at least in part on the first RACH configuration, wherein the first valid RO is applicable for wireless communication with the first TRP and the second TRP, and wherein a second mapping between one or more SSBs and one or more ROs is applicable for a second valid RO based at least in part on the second RACH configuration, wherein the second valid RO is applicable for wireless communication with the second TRP, and transmitting, based at least in part on the at least two RACH configurations, a random access preamble on a selected RO from the first valid RO and the second valid RO.

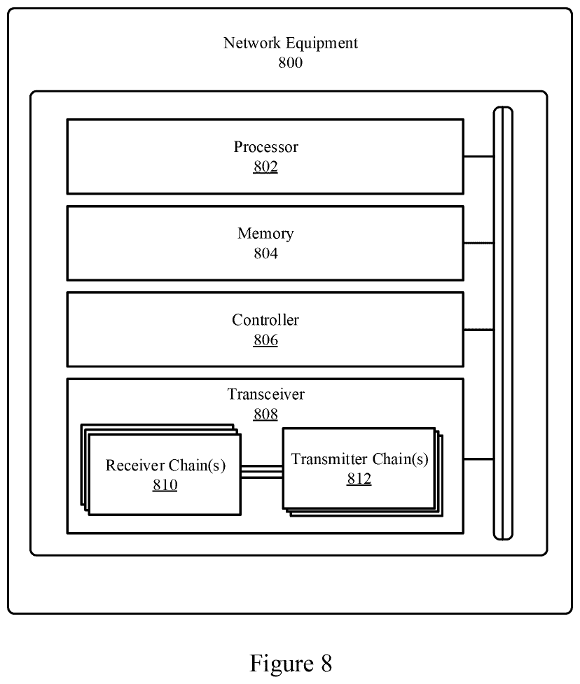

FIG. 8 illustrates an example of a NE 800 in accordance with aspects of the present disclosure. The NE 800 may include a processor 702, a memory 704, a controller 706, and a transceiver 808. The processor 802, the memory 704, the controller 706, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804).

For example, the processor 802 may support wireless communication at the NE 800 in accordance with examples as disclosed herein. The NE 800 may be configured to support a means for transmitting a RACH message that contains a first RACH configuration for a first TRP and a second RACH configuration for a second TRP, and receiving, from a UE, a PRACH preamble based on the first RACH configuration and the second RACH configuration.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

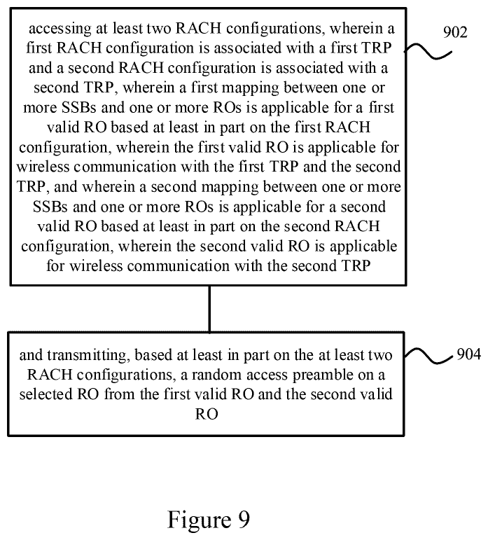

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include accessing at least two RACH configurations, wherein a first RACH configuration is associated with a first TRP and a second RACH configuration is associated with a second TRP, wherein a first mapping between one or more SSBs and one or more ROs is applicable for a first valid RO based at least in part on the first RACH configuration, wherein the first valid RO is applicable for wireless communication with the first TRP and the second TRP, and wherein a second mapping between one or more SSBs and one or more ROs is applicable for a second valid RO based at least in part on the second RACH configuration, wherein the second valid RO is applicable for wireless communication with the second TRP. The operations of 902 may be performed in accordance with examples as described herein. In some implementations, aspects of the operations of 902 may be performed by a UE as described with reference to FIG. 6.

At 904, the method may include transmitting, based at least in part on the at least two RACH configurations, a random access preamble on a selected RO from the first valid RO and the second valid RO. The operations of 904 may be performed in accordance with examples as described herein. In some implementations, aspects of the operations of 904 may be performed by a UE as described with reference to FIG. 6.

It should be noted that the method described herein describes a possible implementation, and that the operations and the steps may be rearranged or otherwise modified and that other implementations are possible.

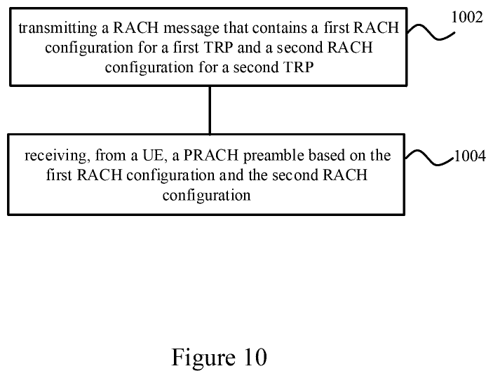

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include transmitting a RACH message that contains a first RACH configuration for a first TRP and a second RACH configuration for a second TRP. The operations of 1002 may be performed in accordance with examples as described herein. In some implementations, aspects of the operations of 1002 may be performed by an NE as described with reference to FIG. 8.

At 1004, the method may include receiving, from a UE, a PRACH preamble based on the first RACH configuration and the second RACH configuration. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
access at least two random access channel (RACH) configurations,
wherein a first RACH configuration is associated with a first transmission and reception point (TRP) and a second RACH configuration is associated with a second TRP,
wherein a first mapping between one or more synchronization signal blocks (SSBs) and one or more RACH occasions (ROs) is applicable for a first valid RO based at least in part on the first RACH configuration, wherein the first valid RO is applicable for wireless communication with the first TRP and the second TRP, and
wherein a second mapping between one or more SSBs and one or more ROs is applicable for a second valid RO based at least in part on the second RACH configuration, wherein the second valid RO is applicable for wireless communication with the second TRP; and
transmit, based at least in part on the at least two RACH configurations, a random access preamble on a selected RO from the first valid RO and the second valid RO.

2. The UE of claim 1, wherein the first TRP supports downlink (DL) and uplink (UL) and the second TRP supports a UL-only capability.

3. The UE of claim 1, wherein the at least one processor is configured to cause the UE to receive the first RACH configuration and the second RACH configuration via a system information block (SIB) associated with the first TRP during a downlink synchronization procedure.

4. The UE of claim 3, wherein the SIB includes a first RACH-ConfigCommon information element (IE) to indicate the first RACH configuration and a second RACH-ConfigCommon IE to indicate the second RACH configuration.

5. The UE of claim 3, wherein the SIB includes:
a shared RACH-ConfigCommon information element (IE) to indicate the first RACH configuration and the second RACH configuration; and
a RACH configuration parameter that offsets second TRP parameters of the second RACH configuration.

6. The UE of claim 1, wherein the at least one processor is further configured to cause the UE to determine one or more valid RO slots for the second TRP based on candidate RO slots indicated by the first RACH configuration.

7. The UE of claim 1, wherein the at least one processor is further configured to cause the UE to determine one or more valid RO slots shared by the first TRP and the second TRP and determine one or more valid slots unique to the first TRP and the second TRP.

8. The UE of claim 1, wherein the at least one processor is further configured to cause the UE to:
transmit a PRACH preamble on an RO of an RO group selected from:
a group of ROs valid for the first TRP and the second TRP;
a group of ROs only valid for the first TRP; or
a group of ROs only valid for the second TRP.

9. The UE of claim 1, wherein the at least one processor is further configured to cause the UE to:
transmit a PRACH preamble on an RO of a first available group of ROs.

10. A network entity for wireless communication, comprising:
at least one memory; and
at least one processor coupled with the at least one memory and configured to cause the network entity to:
transmit a random access channel (RACH) message that contains a first RACH configuration for a first transmission and reception point (TRP) and a second RACH configuration for a second TRP; and
receive, from a user equipment (UE), a physical RACH (PRACH) preamble based on the first RACH configuration and the second RACH configuration.

11. The network entity of claim 10, wherein the first RACH configuration and the second RACH configuration are associated with a shared synchronization signal block (SSB) to RACH occasion (RO) (SSB-to-RO) mapping between first TRP and the second TRP.

12. The network entity of claim 10, wherein the first TRP supports downlink (DL) and uplink (UL) and the second TRP supports a UL-only capability.

13. The network entity of claim 10, wherein the at least one processor is configured to cause the network entity to transmit the first RACH configuration and the second RACH configuration via a system information block (SIB).

14. The network entity of claim 13, wherein the SIB includes a first RACH-ConfigCommon information element (IE) to indicate the first RACH configuration and a second RACH-ConfigCommon IE to indicate the second RACH configuration.

15. The network entity of claim 13, wherein the SIB includes:
a shared RACH-ConfigCommon information element (IE) to indicate the first RACH configuration and the second RACH configuration; and
a RACH configuration parameter that offsets second TRP parameters of the second RACH configuration.

16. A method performed by a user equipment (UE), the method comprising:
accessing at least two random access channel (RACH) configurations,
wherein a first RACH configuration is associated with a first transmission and reception point (TRP) and a second RACH configuration is associated with a second TRP,
wherein a first mapping between one or more synchronization signal blocks (SSBs) and one or more RACH occasions (ROs) is applicable for a first valid RO based at least in part on the first RACH configuration, wherein the first valid RO is applicable for wireless communication with the first TRP and the second TRP, and
wherein a second mapping between one or more SSBs and one or more ROs is applicable for a second valid RO based at least in part on the second RACH configuration, wherein the second valid RO is applicable for wireless communication with the second TRP; and
transmitting, based at least in part on the at least two RACH configurations, a random access preamble on a selected RO from the first valid RO and the second valid RO.

17. The method of claim 16, wherein the first TRP supports downlink (DL) and uplink (UL) and the second TRP supports a UL-only capability.

18. The method of claim 16, wherein the first RACH configuration and the second RACH configuration are received via a system information block (SIB) associated with the first TRP during a random access procedure.

19. A method performed by a network entity, the method comprising:
transmitting a random access channel (RACH) message that contains a first RACH configuration for a first transmission and reception point (TRP) and a second RACH configuration for a second TRP; and
receiving, from a user equipment (UE), a physical RACH (PRACH) preamble based on the first RACH configuration and the second RACH configuration.

20. The method of claim 19, wherein the first RACH configuration and the second RACH configuration are associated with a shared synchronization signal block (SSB) to RACH occasion (RO) (SSB-to-RO) mapping between first TRP and the second TRP.
